(19) United States
(12) Patent Application Publication
(10) Pub. No.: US 2015/0025982 A1
(43) Pub. Date: Jan. 22, 2015

(54) METHOD AND APPARATUS FOR SOCIAL MEDIA ADVERTISING

(71) Applicant: Popular Pays LLC, Chicago, IL (US)

(72) Inventors: Corbett W. Drummey, Chicago, IL (US); Justin A. Holmes, Chicago, IL (US)

(21) Appl. No.: 14/333,928

(22) Filed: Jul. 17, 2014

Related U.S. Application Data
(60) Provisional application No. 61/847,358, filed on Jul. 17, 2013.

(51) Int. Cl. G06Q 30/02; G06Q 50/00

(52) U.S. Cl. CPC G06Q 30/0277; G06Q 50/01
USPC 705/14.73

(57) ABSTRACT

A system and method for encouraging and rewarding users for providing exposure that is desired by other entities. The reward is at least partially dependent upon the expected and/or actual demonstrated reach and/or impact of the generated exposure.

### RELATED APPLICATIONS

This application claims the benefit of and priority to U.S. Provisional Patent Application Ser. No. 61/847,358, filed Jul. 17, 2013, entitled “METHOD AND APPARATUS FOR SOCIAL MEDIA ADVERTISING,” the entire contents of which being hereby expressly incorporated herein by reference.

### FIELD

The present disclosure generally relates to a method and apparatus for compensating users who provide desired exposure on communication networks, and more particularly to a method and apparatus that provides economic benefit to social media users in exchange for such users providing exposure for brands and/or items to the users' social media contacts.

### BACKGROUND

Various social media platforms provide the ability for multiple users to link to and/or follow other users. Through such connections, users can see, observe, and interact with content provided by other users. Accordingly, each time content is published by a user, that content is potentially exposed to the users' connections and/or followers. Accordingly, such exposure can be used for advertising purposes for goods and services. However, the decentralized nature of independent social media users, and specifically users with the capability to reach a high volume of other users, inhibits an organized system to encourage and compensate such users to use their social media account(s) for such advertising purposes.

### SUMMARY

The present disclosure provides a system and method for encouraging and rewarding users for providing exposure that is desired by other entities. The reward is at least partially dependent upon the expected and/or actual demonstrated reach and impact of the potential/generated exposure.

The features and advantages of the present disclosure described above, as well as additional features and advantages, will be readily apparent to those skilled in the art upon reference to the following description and the accompanying drawings.

### BRIEF DESCRIPTION OF THE DRAWINGS

FIG. 1 is login screen for an application that provides for rewarding users for providing desired exposure;

FIG. 2 is home screen for the application of FIG. 1 where a user has logged in;

FIG. 3 is a screen showing multiple available transactions, including a featured transaction;

FIG. 4 is a screen showing multiple available and sortable transactions (by distance, category, etc.);

FIG. 5 is the screen of FIG. 4 with additional navigation buttons exposed;

FIG. 6 is an offer screen for a selected transaction;

FIG. 7 is a transaction screen suitable for facilitating the selected transaction;

FIG. 8 is a completed transaction screen;

FIG. 9 is a social media account activation screen;

FIG. 10 is an offer screen for various retail offers; and

FIG. 11 is a charge confirmation screen.

FIG. 12 is a block diagram of an example system on which one or more disclosed embodiments may be implemented;

### DETAILED DESCRIPTION OF EMBODIMENTS OF THE INVENTION

The embodiments described below are merely exemplary and are not intended to limit the invention to the precise forms disclosed. Instead, the embodiments were selected for description to enable one of ordinary skill in the art to practice the invention.

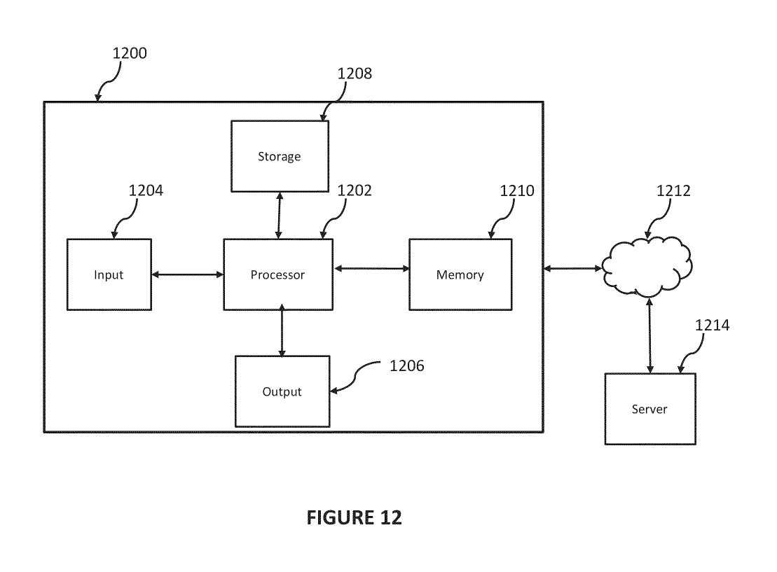

Referring first to FIG. 12, a block diagram is shown of an example device 1200 in which one or more disclosed embodiments may be implemented. As shown, device 1200 is coupled to a server 1214 via a network 1212 such as the internet, a cellular network, etc. In certain embodiments, device 1200 is a handheld device, a mobile phone, or a tablet or other type of computer. Device 1200 generally includes a processor 1202, one or more input devices 1204, one or more output devices 1206, one or more storage devices 1208 and one or more memory devices 1210.

Processor 1202 may include a central processing unit (CPU), a graphics processing unit (GPU), a CPU and GPU located on the same die, or one or more processor cores, wherein each processor core may be a CPU or a GPU. Other types of integrated circuits and processors could also embody aspects of the disclosure including digital signal processors (DSPs), accelerated processing units (APUs), field programmable gate arrays (FPGAs) and the like. Server 1214 may include one or more processors as described above, and while depicted as a single server, may be a distributed server, a server farm or any other suitable configuration of devices.

Input 1204 may include one or more of a keyboard, a keypad, a touch screen/pad, a detector, a camera or recording device, a microphone, an accelerometer, a gyroscope, a biometric scanner, or a network connection (e.g., a wireless local area network card for transmission and/or reception of wireless IEEE 802 signals). Output 1206 may include one or more of a display, a speaker, a printer, a haptic feedback device, one or more indicators, an antenna, or a network connection (e.g., a wireless local area network card for transmission and/or reception of wireless IEEE 802 signals).

Storage 1208 may include a fixed or removable storage component, for example, a hard disk drive, a solid state drive, an optical disk, or a flash drive. Memory 1210 may be located on the same die as processor 1202, or may be located separately from processor 1202. Memory 1210 may include a volatile or non-volatile memory, for example, random access memory (RAM), dynamic RAM, or a cache.

The application according to embodiments of the disclosure may be loaded onto memory 1210 and executed by processor 1202.

It should be appreciated that the attached figures and disclosure discuss embodiments that utilize Instagram. However, it should be appreciated that the concepts described herein are readily extendable to other social media services or any services where a user has a following or other ability to present content to a user base.

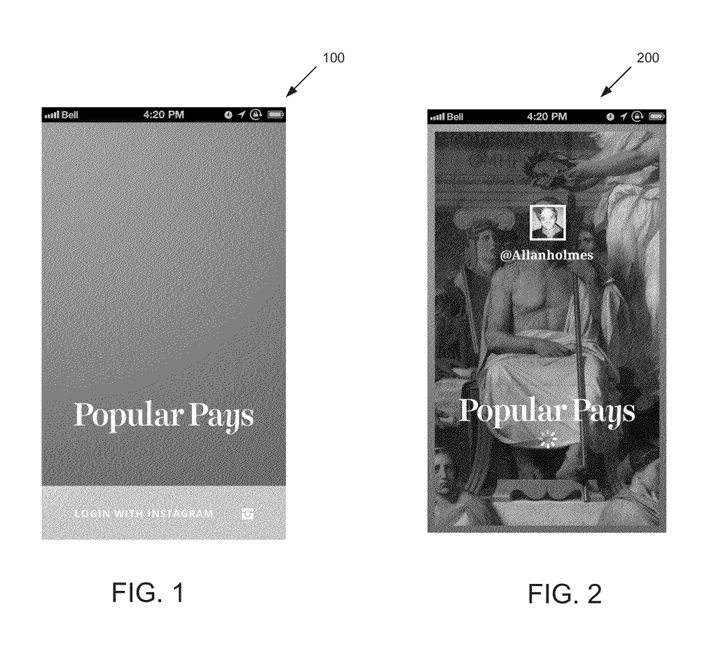

With reference now to FIG. 1, screenshot 100 is a login screen for an application that a user downloads to his/her device 1200. The login screen invites a user to log into a social media service (Instagram) via that service's API or otherwise. FIG. 2 shows screenshot 200 where the login is acknowledged and portions of the application are loading.

Overall, the application provides a conduit for entities that wish to gain exposure to provide compensation, such as goods, services, money, credit, or other items of value to entities capable of providing such exposure.

The value of exposure to content is a function of its breadth (the number of people that get exposed to content), its depth (the extent to which exposed people interact and/or engage with the content), and its quality (the extent to which the exposed people are themselves influential). For purposes of this disclosure, the entity desiring exposure is referenced as the “retailer.” However, it should be appreciated that the entity desiring exposure need not actually be a retailer. Additionally, the potential exposure, depth and quality able to be provided by a user is referred to as the user's “influence.” It should be appreciated that a user may have different influence in different social media platforms. While embodiments are envisioned where influence is calculated by considering multiple social media platforms, each platform can be considered separately. Furthermore, retailers can place differing values on influence in different platforms and tailor/direct their offers accordingly.

In a first embodiment, users of Instagram are presented one or more offers based upon their influence. In one example, a coffee shop offers a free latte to any Instagram user who has more than 500 followers. The free product is provided with the expectation that the user will generate and publish Instagram content that includes the free product (latte) and/or references to the retailer. This content generation and distribution thereby provides advertising in exchange for the free product.

Retailers are able to set the criteria (required influence level) for users to qualify for its various free offerings. While this disclosure refers to the offering of free items, it should also be appreciated that discounted items or any object, experience, or way of providing value to a user are envisioned as being offered.

The application provides a clearinghouse for such offers. The application/clearinghouse also charges a fee for facilitating the transaction. In one embodiment, the retailer is charged a fee per transaction. In one embodiment, the fee charged is a function of the expected value of the exposure to be generated by the user. In another embodiment, the fee charged is a subscription fee that allows the retailer to present offers for a set amount of time.

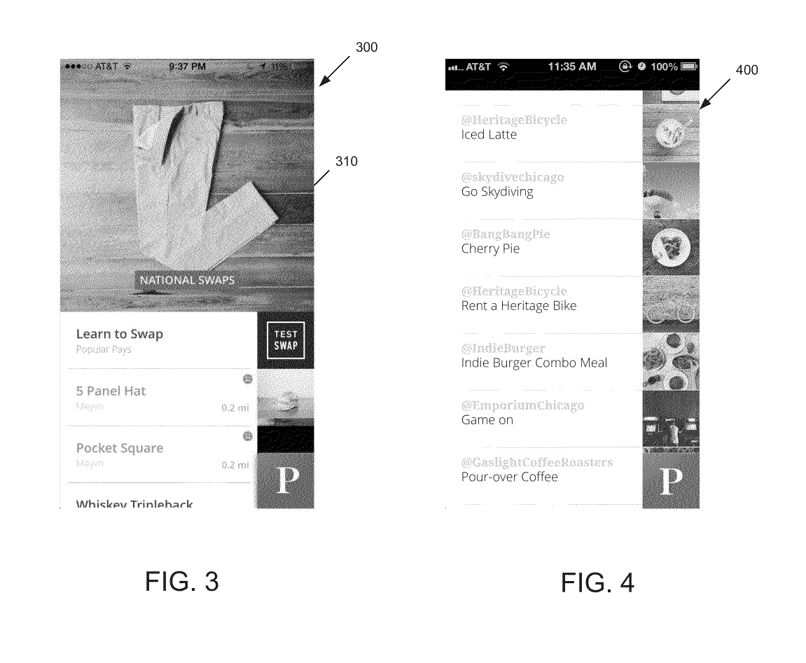

FIG. 3 shows an exemplary screen 300 that presents a user with offers (or swaps) that are available to the user. Screen 300 presents a featured “National” swap 310 which can be redeemed by the user via a coupon code (to be used on the retailer's website) or via the user entering their address and having the retailer mail the product to them in the manner described below. A user can scroll through the available swaps, as shown in FIG. 4, screen 400. Swaps can be organized according to multiple options such as distance from current location, past swap history, popularity, or otherwise.

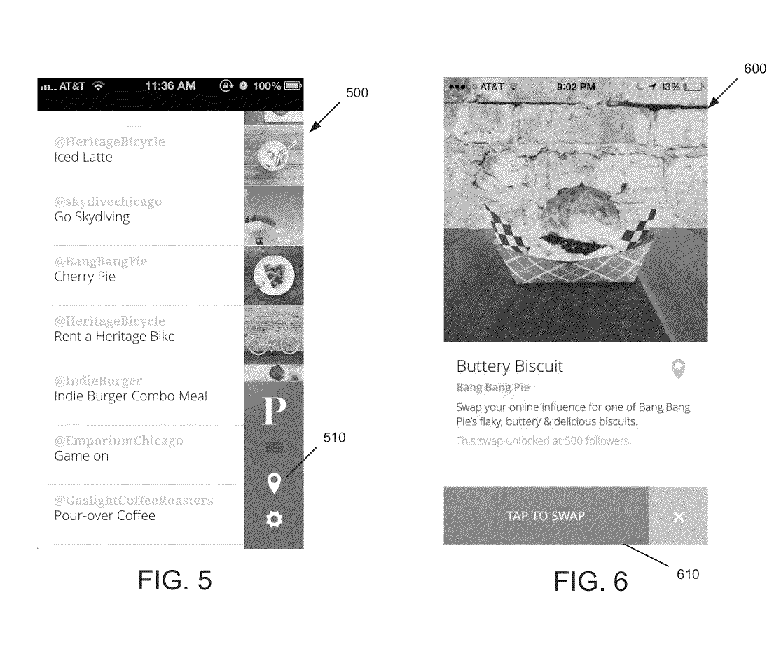

FIG. 5 shows an exemplary screen 500 that presents navigation buttons 510 to the user. Buttons 510 allow plotting of the retailer locations on a map, changing settings, and otherwise.

Once a user selects a swap from the list, screen 600 is displayed with additional details regarding the swap. Such details may include an image of the item being offered, costs or reduced costs for the item, as well as social media information that may be helpful when the user later endeavors to produce content regarding the swap. Button 610 allows the user to select and/or confirm that the swap is actually desired by the user.

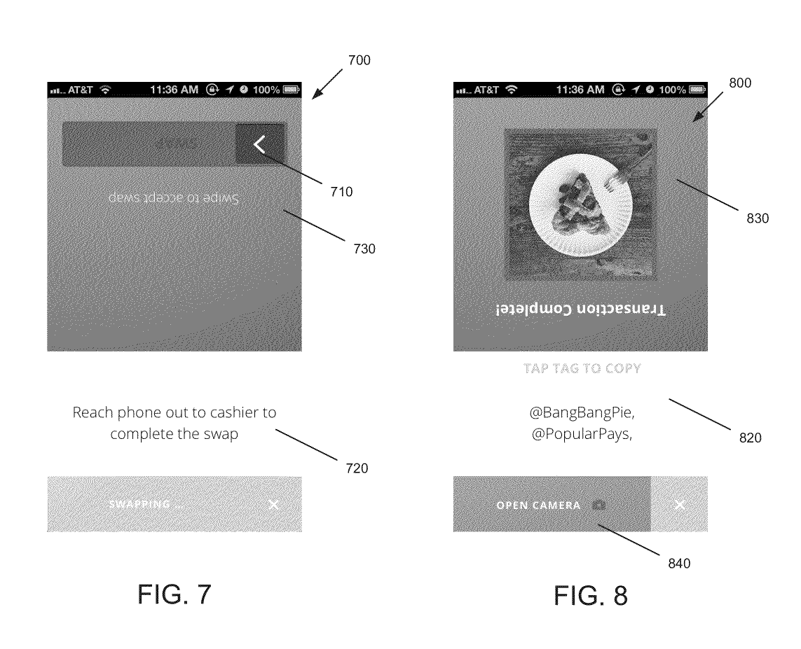

In one embodiment, selection of button 610 takes the user to screen 700 of FIG. 7. Screen 700 presents a split screen. Lower portion 720 presents instructions to a user to present device 1200 to a cashier. Upper portion 730 instructs the cashier to accept the swap, such as by swiping a bar icon 710. Additional embodiments are provided where a UPC or other indicia are provided in upper half 730 that allows the transaction to be automatically registered by the inventory system/cash register of the retailer. It should be appreciated that words displayed on upper portion 730 are up-side down relative to the words on lower portion 720 such that both the user and cashier are able to read their respective portions when the smartphone and screen 700 are between them.

Devices 1200 such as smartphones often have an accelerometer therein that will orient a screen such that lower portion 720 is on the lower part of the screen of a smartphone. In one embodiment, the application of the present disclosure disables the ability of the screen to “re-orient” itself based upon the accelerometer when displaying screen 700. This is potentially useful in case a user extends the phone to a cashier and tilts the phone in a way that would normally cause the screen to re-orient. Such re-orienting would potentially present a cashier with the wrong end of the screen with which to interact. Accordingly, locking out the re-orienting prevents this eventuality. In another embodiment, the accelerometer detects the extension of device 1200 and splits screen 700 to facilitate the transaction.

Upon acceptance of the swap by the cashier, screen 800 of FIG. 8 is presented. Upper portion 830 displays an indication that the transaction was successful and presents an image of the item purchased. Lower portion 820 presents social media indicia, such as Twitter handles, hashtags, or the like that the user is encouraged to make part of the created content. Button 840 is further provided that allows quick access to the camera functionality of the smartphone.

In one embodiment, the application has access to geo location services of device 1200. When a swap occurs, the application reports the swap to a server that manages the back end of the application. Based on a user's geo-location, the application can tell if a swap occurred inside a participating merchant's venue. For a period of time after the cashier swipes the screen to confirm a transaction, the application will check the users' Instagram feed to see if the user posts a photo with metadata indicating that the image was captured at a participating merchant's geo-location. The application also checks if the user posts any photos that were hashtagged using the social media indicia suggested in lower portion 820 in case they take a photo of the brand or product outside of the venue location. For example, for a skydiving swap, users may post photos of themselves getting ready for the jump when they were geo-located outside of the participating merchant's address, but they would still use the social media indicia.

In an alternative embodiment, rather than conducting a swap in person with a cashier as described above, the swap is conducted over a network. For example, a user may desire an item featured in a swap from a distant retailer. The user may tap on the item and be presented with a screen asking for a mailing address. The user inputs the mailing address and the application sends the information to the retailer over a network (e.g., cellular, internet, etc.), who then mails the item to the user, Alternatively, instead of requiring the user to input a mailing address, the application may simply send a notification to the retailer with the user's email address, and the retailer may email a coupon code to the user which may be redeemed to obtain the item.

It should be understood that in the embodiments described above, the retailer is described as providing the item of value in a swap based on the assumption that the user will post content to advertise for the retailer in exchange for the item, In certain embodiments, the application may monitor the user's posts for such content and, upon finding no posts within a certain time period, may push notifications to the user reminding him/her to post. In some embodiments, such as where the item of value is a coupon or is to be mailed to the user, it may be withheld until server 1214 detects content regarding the item and/or the retailer posted to the user's social media account. Alternatively, or in addition, the application may block users who do not post content from future swaps offered by the retailer or from access to any further swaps at all.

Merchants may set a dollar or transaction limit for each month that they are willing to accommodate. Once the limit is reached, the swap will expire and disappear from the application's display. This adds predictability to advertising costs for participating merchants.

According to another embodiment of the application, rather than only offering free items from retailers to users, the social media interactions can gain users credits, “social currency,” that they can then spend. In one example, these credits take the form of a dollar amount that is held in an application account of the user. This dollar amount translates, dollar for dollar, to an actual amount that the user can spend at participating retailers.

Upon a first use, the user is granted a starting balance that is at least partially based upon the user's demonstrated influence. In one example, the starting balance is enough for between 1-3 average priced swaps. Each time users make a swap, they will see their account balance decrease by the menu price of the item they just bought/swapped for, and each time they post a photo or other social media content containing desired content, they will see their balance increase. The amount by which a balance increases is determined by factors such as the influence of the user, the value established by the retailer being featured in the content, and the amount of follower interaction with the content.

Similarly to that previously discussed, with respect to other embodiments of the disclosure, when purchasing with social currency, portions 730, 830 may be set up to display the amount of social currency being deducted from the user's account by completing the swap. This amount would thus be confirmed to a cashier.

A system to implement the above functionality would include one or more back end servers connected to a network that is able to communicate with devices 1200 via a network. The server(s) may optionally be programmatically coupled to point of sale terminals or other computing entities of participating retailers. Alternatively, the server(s) may not be coupled to computing entities of participating retailers. The server(s) may track credits (dollar amounts) owed by retailers due to social media content produced by users that includes content desired by the retailers. Similarly, the server(s) would track the amount of social currency redeemed at the retailer. These amounts would then be used to settle up a net bill due between the application provider and retailers.

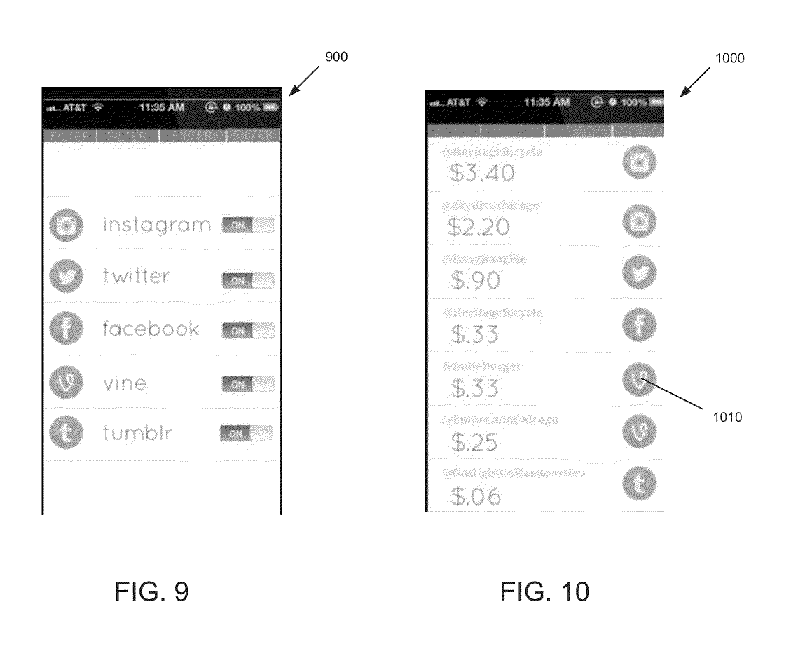

In one embodiment, a user logs into multiple social media accounts via the application, as shown in FIG. 9. These logins are optionally saved between sessions and may be toggled between active and inactive for any session. A second screen, shown in FIG. 10, presents multiple offers that are being presented by retailers. The offers present an indication of the retailer, the payment they are offering for created and shared content, as well as the social media provider, icons 1010, on which the retailer is offering to pay for content. This listing can be searchable and can be filtered (such as by proximity, greatest value, etc).

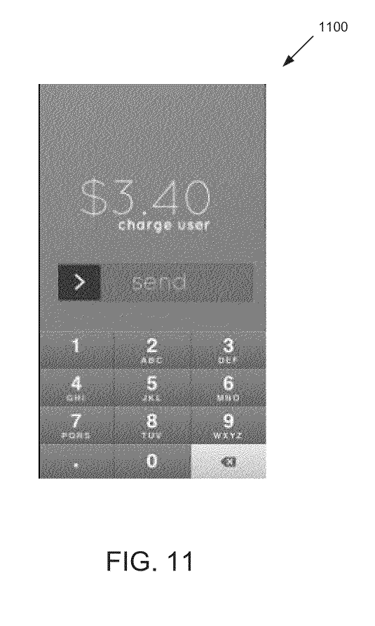

In one embodiment, a user's accrued social currency is spent as follows. When a cashier is informed that a customer wishes to use social currency to pay for all or a part of a retailing transaction, the cashier types a code into the application on the user's device 1200 that identifies the retailer and identifies the amount of social currency being charged by the retailer for the proposed transaction. The cashier is then presented with a confirmation screen such as screen 1100 shown in FIG. 11.

A user would then be presented with a screen that invites the user to accept the transaction. Optionally, such an action may require the entrance of a PIN code or other security feature to prevent unauthorized parties (such as the cashier or otherwise) from entering a charge and then also accepting it.

Upon the acceptance of a social currency outbound payment, the user would see his/her social currency account debited for the agreed amount. As mentioned above, the social currency would then be attributed to the retailer, subject to the “settling up” and net billing discussed above.

It should be appreciated that a user need not explicitly accept an offer, such as the offers shown on screen 1000 to accrue the benefits thereof. A user who has an account with the application and provides desired content can be credited the offered social currency regardless of whether the user was aware of the offer. Accordingly, the user is credited for his/her normal social media content creation.

In one embodiment, a user may make a withdrawal from his/her social currency account to receive US (or another country) currency via deposit to a bank account, via check, via a service like Paypal, or otherwise.

Still further, embodiments are envisioned where the application is able to take advantage of NFC capabilities in devices 1200 to communicate with point-of-sale terminals.

In another feature of the application, the quality of the users is determined not just by the number of followers they have, but also based on a determination of whether the user is highly relevant for a particular retailer. For example, for more expensive deals, like an expensive dress shirt, the retailer may want to target the swap only to certain users. It is known that online, “Like follows Like,” so that food enthusiast Instagrammers follow each other, skateboarders follow each other, outdoor enthusiasts follow each other, etc. The application may be configured to analyze who follows whom and mark the strong overlapping nodes on that network as the quality users. If the retailer wants fashion influencers like @grantlegan and @lusttforlife, the application analyzes who those entities follow and counts up the overlapping occurrences. Then it ranks the overlapping occurrences and searches to see if those people are users of the application. If they are, the application serves the deal to them and notifies them that it is available. If they are not, the application may determine whether their email is publicly available, and if so, email them the opportunity to join the application and be presented such deals.

The foregoing description of the invention is illustrative only, and is not intended to limit the scope of the invention to the precise terms set forth. Although the invention has been described in detail with reference to certain illustrative embodiments, variations and modifications exist within the scope and spirit of the invention as described and defined in the following claims.

What is claimed is:

1. A system for compensating content producers including:
a server; and
a device coupled to the server via a network, the device including a processor, an input device, an output device, and a memory having instructions that are accessible by the processor and configured such that when executed by the processor, the instructions cause the processor to present one or more commercial opportunities to a user via the output device; enable the user to select one of the commercial opportunities using the input device, and facilitate acceptance of the user selection of the commercial opportunity by the provider of the commercial opportunity;
wherein the server is configured to respond to acceptance of the commercial opportunity by monitoring one or more social media platforms for content generated by the user containing desired information regarding one of the commercial opportunity and the provider.

2. The system of claim 1, wherein the user is compensated upon the detection of content generated by the user containing desired information regarding one of the commercial opportunity and the provider.

3. The system of claim 1, wherein the input device and the output device function together as a touch-sensitive display.

4. The system of claim 1, wherein the server is further configured to determine a charge to the provider of the commercial opportunity based on an expected level of exposure the content containing desired information will receive.

5. The system of claim 4, wherein the expected level of exposure is based on a number of followers the user has on the one or more social media platforms.

6. The system of claim 5, wherein the expected level of exposure is further based on a determination of relevance of the user and the user's followers to the commercial opportunity.

7. The system of claim 1, wherein facilitating acceptance of the user selection includes displaying an icon on the output device for a representative of the provider to actuate.

8. The system of claim 7, wherein the icon is displayed for viewing by the representative but is upside down from a perspective of the user.

9. The system of claim 7, wherein the processor disables an accelerometer of the device while displaying the icon on the output device.

10. The system of claim 1, wherein the instructions, when executed, further cause the processor to display an image relating to the commercial opportunity on the output device and one or more links to social media platforms.

11. The system of claim 1, wherein facilitating acceptance of the user selection includes displaying a request for the user's address information and sending the address information to the provider over a network.

12. The system of claim 1, wherein the server responds to a failure to detect the content generated by the user by sending a notification to the user.

13. The system of claim 1, wherein the commercial opportunity includes social currency which the user can use to purchase items.

14. A method for compensating content producers including:
presenting, using a processor, a plurality of commercial opportunities to a user on an output device;
receiving an indication of the user's selection of one of the commercial opportunities via an input device;
displaying, via the output device, an acceptance screen having an icon, actuation of which indicating willingness of a provider of the selected commercial opportunity to provide the commercial opportunity to the user; and
in response to actuation of the icon, prompting the user to log into a social media platform to post content related to at least one of the selected commercial opportunity and the provider.

15. The method of claim 14, further including monitoring the social media platform to determine whether the user posts content related to at least one of the selected commercial opportunity and the provider.

16. The method of claim 15, further including providing the selected commercial opportunity to the user in response to determining that the user posted the content.

17. The method of claim 14, further including determining a charge to the provider of the selected commercial opportunity based on an expected level of exposure the content will receive.

18. The method of claim 17, wherein the expected level of exposure is based on a number of followers the user has on the social media platform.

19. The method of claim 14, wherein the icon is displayed for viewing by a representative of the provider but is upside down from a perspective of the user.

20. The method of claim 14, further including disabling an accelerometer while displaying the icon on the output device.

21. The method of claim 14, further including displaying a request for the user's address information and sending the address information to the provider over a network.
